(19) United States
(12) Patent Application Publication
(10) Pub. No.: US 2023/0361523 A1
(43) Pub. Date: Nov. 9, 2023

(54) PASSIVE MODE-COUPLED FIBER OSCILLATOR AND LASER DEVICE HAVING SUCH A FIBER OSCILLATOR

(71) Applicant: TRUMPF Laser GmbH, Schramberg (DE)

(72) Inventors: Florian Graf, Aichhalden (DE); Aleksander Budnicki, Waldkirch (DE)

(21) Appl. No.: 18/337,445

(22) Filed: Jun. 20, 2023

Related U.S. Application Data
(63) Continuation of application No. PCT/EP2021/084580, filed on Dec. 7, 2021.

(30) Foreign Application Priority Data
Dec. 21, 2020 (DE) 10 2020 216 434.7

(51) Int. Cl. H01S 3/08; H01S 3/094; H01S 3/067; H01S 3/16

(52) U.S. Cl. CPC H01S 3/06725; H01S 3/0675; H01S 3/06791; H01S 3/08013; H01S 3/094003; H01S 3/094076; H01S 3/1603

(57) ABSTRACT

A passive mode-coupled fiber oscillator includes a bidirectional loop, a unidirectional loop, and a 3x3 coupler. The bidirectional loop and the unidirectional loop are coupled to one another via the 3x3 coupler. The bidirectional loop includes a first amplification fiber that is doped using at least one element selected from the group consisting of ytterbium, neodymium, erbium, thulium, and holmium. The fiber oscillator further includes a dispersion compensation element. The fiber oscillator has an anomalous dispersion overall.

### CROSS REFERENCE TO RELATED APPLICATIONS

This application is a continuation of International Application No. PCT/EP2021/084580 (WO 2022/135911 A1), filed on Dec. 7, 2021, and claims benefit to German Patent Application No. DE 10 2020 216 434.7, filed on Dec. 21, 2020. The aforementioned applications are hereby incorporated by reference herein.

### FIELD

Embodiments of the present invention relate to a passive mode-coupled fiber oscillator and a laser device, comprising a pump light source and such a fiber oscillator.

### BACKGROUND

Passive mode-coupled fiber oscillators often have a saturable absorber, in particular a semiconductor-based saturable absorber mirror (Semiconductor Saturable Absorber Mirror), abbreviated SESAM. Such a SESAM is susceptible to degradation and misalignment, however. Because of this, it has proven to be difficult to provide such a mode-coupled fiber oscillator reproducibly in the wavelength ranges from approximately 900 nm to approximately 2100 nm for long-term-stable operation in an industrial environment. In particular these wavelength ranges are of interest for material processing and the telecommunications field, on the one hand, and the medical-technology field and semiconductor processing, on the other hand. It has furthermore proven to be a challenge to provide such a fiber oscillator having well-defined dispersion properties. Amplifier systems, in which the pulses are subjected to stronger self-phase modulation, are moreover typically susceptible to irregularities in the spectral properties, which can then have negative effects on the output pulse quality.

### SUMMARY

Embodiments of the present invention provide a passive mode-coupled fiber oscillator. The fiber oscillator includes a bidirectional loop, a unidirectional loop, and a 3x3 coupler. The bidirectional loop and the unidirectional loop are coupled to one another via the 3x3 coupler. The bidirectional loop includes a first amplification fiber that is doped using at least one element selected from the group consisting of ytterbium, neodymium, erbium, thulium, and holmium. The fiber oscillator further includes a dispersion compensation element. The fiber oscillator has an anomalous dispersion overall.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first exemplary embodiment of a passive mode-coupled fiber oscillator;

FIG. 2 shows a schematic illustration of a second exemplary embodiment of a passive mode-coupled fiber oscillator;

FIG. 3 shows a schematic illustration of a third exemplary embodiment of a passive mode-coupled fiber oscillator; and

FIG. 4 shows a schematic illustration of a fourth exemplary embodiment of a passive mode-coupled fiber oscillator.

### DETAILED DESCRIPTION

Embodiments of the present invention provide a passive mode-coupled fiber oscillator, which includes a bidirectional loop and a unidirectional loop. The bidirectional loop and the unidirectional loop are coupled to one another by a 3×3 coupler. The bidirectional loop includes a first amplification fiber, which is doped using at least one element, selected from a group consisting of ytterbium, neodymium, erbium, thulium, and holmium. The fiber oscillator includes a dispersion compensation element and an anomalous dispersion overall. The bidirectional loop can advantageously assume the function of a saturable absorber, so that the fiber oscillator can in particular dispense with a SESAM. The problem of degradation and misalignment in conjunction with a SESAM is therefore also completely avoided. In particular, no problems with degradation and/or misalignment occur in conjunction with the bidirectional loop. By suitable selection of the first amplification fiber, in particular an element using which the first amplification fiber is doped, suitable wavelengths can be provided for the fiber oscillator, in particular in the range from approximately 900 nm to 1100 nm (ytterbium, neodymium) via 1500 nm (erbium) to approximately 1900 to 2100 nm (thulium, holmium). Well-defined dispersion properties are provided by tuning of the overall dispersion of the fiber oscillator in the anomalous range. The dispersion is advantageously shifted into the anomalous range here with the aid of the dispersion compensation element if ytterbium or neodymium is used as a doping element. If erbium, thulium, or holmium is used as the doping element, the dispersion compensation element can advantageously be used to reduce the dispersion within the anomalous range, in particular to be able to implement shorter laser pulses with respect to time. In particular, the formation of pulses which are spectrally broader and therefore shorter with respect to time can be favored in relation to a classic soliton oscillator. The fiber oscillator in particular enables reproducible operation with long-term stability in an industrial environment in the mentioned wavelength ranges. The anomalous dispersion range proves to be advantageous here, in particular due to the generation of solitons or dispersion-managed solitons, since in this range the spectral properties, in particular the spectral form, of short pulses are well suitable for amplification technologies such as chirped pulse amplification in particular, in particular in systems having high proportions of nonlinearities, in particular self-phase modulation, since otherwise irregularities in this case can have a negative effect on the output pulse quality.

In one embodiment, the first amplification fiber is doped using precisely one of the elements, selected from the group consisting of ytterbium, neodymium, erbium, thulium, and holmium. In another embodiment, the first amplification fiber is doped using a combination of at least two of the mentioned elements, in particular using a combination of precisely two of the mentioned elements. In one embodiment, the first amplification fiber is doped using erbium and ytterbium (Er/Yb). In another embodiment, the first amplification fiber is doped using thulium and holmium (Tm/Ho).

A fiber oscillator is understood in particular as a laser oscillator which includes at least one optical component, in particular for light guiding and/or light influencing, which includes a fiber or consists of a fiber. In one preferred embodiment, it is possible that all optical components of the fiber oscillator are fiber components, i.e., components which in particular include a fiber or consist of a fiber, in particular fiber-based components or fiber-coupled components.

A loop is understood as an optical part of the fiber oscillator, which includes a first end and a second end, wherein both the first end and the second end are coupled to the same connection component of the fiber oscillator, in particular to the 3×3 coupler here. This means in particular that light pulses which pass through the loop starting from the connection component arrive back at the connection component again along the loop. Such a loop can be formed as a ring overall; in particular the loop consists of a ring part in this case. However, it is also possible that such a loop includes at least one ring part and at least one linear branch connected to the ring part in a light-conducting manner, in particular precisely one ring part and precisely one linear branch.

A bidirectional loop is understood in particular as a loop in which light pulses can propagate both from the first end toward the second end and also from the second end toward the first end - thus in both directions.

A unidirectional loop is understood in particular as a loop in which light pulses can only propagate along the loop in one singular direction, either from the first end toward the second end or from the second end toward the first end, along the loop. An isolator device, in particular an isolator, is preferably arranged in the unidirectional loop, wherein the isolator device is configured to transmit light pulses only in one direction, but to block them in the other direction, for example by utilizing the Faraday effect, or in another suitable manner. The isolator device is preferably arranged in a ring part of the unidirectional loop.

The bidirectional loop is preferably a first fiber loop.

A fiber loop is understood here as a loop which includes a fiber or consists of a fiber in at least some regions. In one preferred embodiment, the fiber loop consists as a whole of a fiber or is composed of a plurality of fibers connected to one another.

The unidirectional loop is preferably a second fiber loop. The unidirectional loop is preferably formed in particular as a unidirectional ring.

In one embodiment, the bidirectional loop includes an asymmetry. In particular, it is provided in one embodiment that the bidirectional loop is designed asymmetrically for two light pulses passing through the bidirectional loop in opposite directions. In particular, the bidirectional loop includes an asymmetry element, in particular an asymmetrically arranged amplification element for an asymmetrical amplification, and/or an asymmetrically arranged attenuation element for an asymmetrical attenuation, of the light pulses propagating in opposite directions along the bidirectional loop. The asymmetry element is generally configured and/or arranged to generate a distinction in the respective self-phase modulation between a light pulse propagating in a first direction along the bidirectional loop and a light pulse propagating in the other second direction along the bidirectional loop.

The asymmetrically arranged amplification element is preferably variably adjustable with respect to the amplification. In particular if the first amplification fiber is designed as the amplification element, a variable amplification can be implemented by variation of the pump power.

Alternatively or additionally, the asymmetrically arranged attenuation element is preferably variably adjustable with respect to the attenuation.

In general, a variable phase shift between the two light pulses running in opposite directions in the bidirectional loop can be implemented via a variable adjustment of the asymmetry element; in particular, the phase shift can be adjusted by variable activation of the asymmetry element.

In particular, according to one embodiment the first amplification fiber as an amplification element can be arranged asymmetrically in the bidirectional loop. This means in particular that the first amplification fiber is arranged closer to the first end of the bidirectional loop than to the second end, or vice versa. Alternatively, according to another embodiment it can be provided that an asymmetrically arranged attenuation element, in particular an asymmetrically arranged decoupling element, for example a tap coupler, or a filter, a polarization attenuator, or the like is arranged in the bidirectional loop. The mentioned embodiments can also be combined with one another.

In particular, the bidirectional loop is preferably designed as a Nonlinear Amplifying Loop Mirror (NALM). In this case, the bidirectional loop includes an asymmetry, so that in particular light pulses which pass through the bidirectional loop in various directions pass a longer part of the bidirectional loop with different intensity level depending on their circulation direction, since – with respect to the route of the bidirectional loop – they are amplified and/or attenuated earlier or later. Due to the self-phase modulation in the bidirectional loop, this results in a phase shift between two light pulses passing through the bidirectional loop in opposite directions to one another, wherein this phase shift is itself in turn intensity-dependent. The phase shift between the two light pulses in turn influences their coupling behavior at the 3×3 coupler. In this way, light pulses only above an intensity threshold are effectively fed in the matching propagation direction via the 3×3 coupler from the bidirectional loop into the unidirectional loop, due to which in particular the bidirectional loop designed as the NALM can fulfill the function of a saturable absorber.

The loop arrangement made up of the bidirectional loop and the unidirectional loop, which are coupled with one another via the 3×3 coupler, and therefore the fiber oscillator as a whole, preferably has a so-called figure-8 configuration.

The 3×3 coupler preferably includes a plurality of ports, in particular six ports. The 3×3 coupler is preferably formed symmetrically, which means in particular that light pulses are allocated in equal proportions onto the various ports of the 3×3 coupler. A port is understood here as a connection of the 3×3 coupler, which can act as an input or as an output and in particular can be connected to a fiber in a light-conducting manner.

The 3×3 coupler preferably includes three ports on a first side, namely a first port, a second port, and a third port. On a second side, the 3×3 coupler includes three further ports, namely a fourth port, a fifth port, and a sixth port. The first port is directly connected in a light-conducting manner via a fiber section to the fourth port. The second port is directly connected in a light-conducting manner via a fiber section to the fifth port. The third port is directly connected in a light-conducting manner via a fiber section to the sixth port. Light pulses which propagate between two ports directly connected to one another do not experience a phase jump. However, the 3×3 coupler is configured so that light pulses can cross talk between the direct connections of the ports, wherein they experience a phase shift, which preferably – independently of which two direct connections a light pulse cross talks between – is 2π/3.

According to one embodiment of the invention, the 3×3 coupler is generally configured to convey a phase shift of 2π/3 to light pulses which cross talk between various direct connections of the ports of the 3×3 coupler. This enables in particular a corresponding phase shift to be conveyed to the two light pulses running in opposite directions in the NALM.

An embodiment of the 3×3 coupler is described hereinafter in consideration of the best possible arrangement and linking of ports of the 3×3 coupler. A person skilled in the art readily recognizes here that numerous other embodiments exist, which are equivalent, nearly equivalent, or at least functionally identical to the described arrangement, but at least fulfill the same purpose.

In particular, a first end of the unidirectional loop is connected in a light-conducting manner to the third port. A second end of the unidirectional loop is connected in a light-conducting manner to the first port. The unidirectional loop is configured in such a way – in particular by the isolator device – that a light pulse can only pass along the unidirectional loop from the third port to the first port, but not in the reverse direction.

A first end of the bidirectional loop is connected in a light-conducting manner to the fifth port. A second end of the bidirectional loop is connected in a light-conducting manner to the sixth port. The second port and the fourth port can preferably be used to decouple light pulses from the fiber oscillator, whether as useful light or for monitoring.

A light pulse entering from the unidirectional loop via the first port into the 3×3 coupler is allocated there in three light pulses having equal pulse energy onto the fourth port, the fifth port, and the sixth port. The light pulses at the fifth port and at the sixth port each experience the phase shift of 2π/3 in relation to the light pulse entering at the first port. The light pulse at the fifth port is designated hereinafter as the first light pulse, the light pulse at the sixth port as the second light pulse. The first light pulse now passes through the bidirectional loop starting from the first end toward the second end – namely from the fifth port to the sixth port, wherein the second light pulse passes through the bidirectional loop in the reverse direction – namely from the sixth port to the fifth port.

Due to the asymmetrical design of the bidirectional loop, the first light pulse and the second light pulse experience different phase shifts or B integrals during their propagation along the bidirectional loop. The difference in the B integrals or the phase shift between the first light pulse and the second light pulse is in particular dependent on the original intensity of the light pulses – before passing through the bidirectional loop – and the amplification and/or attenuation in the first amplification fiber, thus in particular on a pump level of the first amplification fiber. The attenuation can also be designed variably if necessary to influence the phase shift.

Arriving at the fifth port, the second light pulse now partially cross talks via the direct optical connection between the sixth port and the third port and again experiences a phase shift of 2π/3. The first light pulse arriving at the sixth port is passed on directly to the third port without experiencing a phase shift. An output pulse at the third port resulting by superposition of the first light pulse and the second light pulse is therefore in particular dependent on the B integrals, which the light pulses experience during their propagation along the bidirectional loop.

The 3×3 coupler is configured here so that even at negligible nonlinear phase shift between the first light pulse and the second light pulse, a finite transmission of preferably approximately 10% of the input pulse energy and a non-negligible slope of the phase-dependent transmission curve results, which significantly simplifies a laser pulse buildup out of the noise. In particular, this facilitates the start, in particular a self-start, of the mode-coupled operation. With increasing phase shift, the transmission increases up to a maximum of preferably approximately 45% - without consideration of the amplification by the first amplification fiber -at a maximum phase shift of 2π/3.The bidirectional loop therefore favors light pulses having greater peak power and can thus fulfill the function of a saturable absorber.

The nonlinear phase shift between the first light pulse and the second light pulse may be variably adjusted by variation of the pump power for the first amplification fiber in the bidirectional loop.

The first amplification fiber is doped using at least one element, which is selected from a group consisting of: ytterbium, neodymium, erbium, thulium, and holmium. The doping element or possibly the combination of doping elements determines in particular an optical wavelength for the fiber oscillator: if the first amplification fiber comprises ytterbium or neodymium as the doping element, the wavelength is at approximately 900 to 1100 nm; the fiber oscillator is then preferably used for processing transparent materials or for telecommunication. If the first amplification fiber comprises erbium as the doping element, the wavelength is at approximately 1500 nm; the fiber oscillator is then preferably used in particular in telecommunication applications or in the medical field. If the first amplification fiber comprises thulium or holmium as the doping element, the wavelength is at approximately 1900 to 2100 nm; the fiber oscillator is then preferably used in particular in semiconductor technology or in the field of medical technology.

The fiber oscillator having an anomalous, i.e., negative dispersion overall, or - in other words but synonymously - an overall dispersion of the fiber oscillator being in the anomalous dispersion range means in particular that a light pulse passing through the fiber oscillator has experienced an anomalous dispersion after a pass through the fiber oscillator - that is to say, each component of the fiber oscillator was passed once. This in turn means that in comparison to a chronological form of the light pulse before the pass through the fiber oscillator, in the chronological form of the light pulse after the pass through the fiber oscillator, higher frequencies lead due to dispersion, while lower frequencies trail. Higher frequencies thus run through the fiber oscillator faster than lower frequencies. However, this effect can be at least partially compensated for by other effects, in particular nonlinearities, in particular by nonlinear self-phase modulation. The fiber oscillator overall having an anomalous dispersion does not necessarily mean that each optical component of the fiber oscillator has an anomalous dispersion; rather, the effect results at least for the sum of the optical components. While it is therefore possible in one preferred embodiment that all optical components of the fiber oscillator have an anomalous dispersion, it is also possible in another preferred embodiment that at least one first optical component of the fiber oscillator has a normal – positive – dispersion, wherein the fiber oscillator includes at least one other, second optical component which has an anomalous dispersion which overcompensates for the normal dispersion of the first optical component, so that the dispersion of the fiber oscillator is anomalous overall.

In one embodiment of the fiber oscillator, both the unidirectional loop and the bidirectional loop each have an anomalous dispersion.

If the wavelength of the fiber oscillator is in the anomalous dispersion range, for example upon the use of erbium, thulium, or holmium as doping elements, preferably no further additional measures are required, in particular no dispersion compensation elements, in order to keep the overall dispersion of the fiber oscillator in the anomalous range. The fiber oscillator can, however, according to one embodiment, also include at least one dispersion compensation element in such a case in order to reduce the absolute value of the overall dispersion, in particular to bring it into the vicinity of the normal dispersion range, and thus to obtain pulses which are spectrally broader and thus shorter with respect to time. A dispersion compensation element used for this purpose can, according to one embodiment, in particular be designed as a dispersion compensation fiber or as a grating, in particular as a fiber-Bragg grating. Such a dispersion compensation fiber is also designated as a dispersion-compensated fiber or dispersion-matched fiber. Such a dispersion compensation fiber can include a fiber core, for example, which comprises rings having different indices of refraction.

If the overall dispersion of the fiber oscillator is in the anomalous dispersion range, preferably solitons form in the fiber oscillator or, in the case of the dispersion-compensated fiber oscillator – in particular upon the use of ytterbium or neodymium as doping elements -dispersion-managed solitons. The anomalous dispersion on the one hand and the nonlinear self-phase modulation have different signs, so that the phase differences which arise due to dispersion on the one hand and self-phase modulation on the other hand mutually cancel out at least substantially, preferably completely.

If the wavelength of the fiber oscillator is in the normal dispersion range, for example upon the use of ytterbium or neodymium as doping elements, the fiber oscillator preferably includes at least one dispersion compensation element to bring the overall dispersion into the anomalous range. The at least one dispersion compensation element is preferably designed as a chirped grating, in particular as a chirped fiber-Bragg grating. The dispersion compensation element is preferably arranged in the unidirectional loop.

According to one embodiment of the invention, it is provided that the unidirectional loop does not include an amplification medium. In this case, the first amplification fiber is advantageously the only amplification medium of the fiber oscillator, in particular the only amplification fiber. The fiber oscillator can therefore have a very simple and inexpensive structure.

In an alternative preferred embodiment, it is provided that the unidirectional loop includes an – additional – amplification medium, in particular a second amplification fiber, wherein an isolator element – in a preferred embodiment the isolator device of the unidirectional loop provided in any case – is arranged in the propagation direction of a light pulse in the unidirectional loop between the amplification element and the first amplification fiber. Additionally or alternatively, an isolator element is preferably arranged in the propagation direction of the light pulse between the first amplification fiber and the amplification element. In this way, in particular losses can advantageously be compensated for in that an amplification of light pulses in the fiber oscillator takes place not only in the first amplification fiber, but also in the additional amplification medium. At the same time, this enables greater freedom in the selection of the amplification for the first amplification fiber and therefore a freer adaptation of the phase shift between the first light pulse and the second light pulse, since a change of the overall amplification of the fiber oscillator upon variation of the amplification in the first amplification fiber can accordingly be compensated for by means of the additional amplification medium. The isolator element can be designed in one preferred embodiment as an isolator or as a circulator.

The second amplification fiber is preferably doped using the same element as the first amplification fiber.

The bidirectional loop preferably includes a coupling device which is configured to couple pump light into the first amplification fiber. The coupling device arranged in the bidirectional loop can also be used at the same time to couple pump light into the additional amplification medium, in particular into the second amplification fiber. In addition, the preferably asymmetrically arranged coupling device can be used as an asymmetry element, in particular as an asymmetrically arranged attenuation element.

Alternatively, it is preferably possible that a coupling device is arranged in the unidirectional loop which is configured to couple pump light into the additional amplification medium, in particular the second amplification fiber. The coupling device is preferably also used at the same time for coupling pump light into the first amplification fiber.

Alternatively, it is preferably also possible that the bidirectional loop includes a first coupling device for coupling pump light into the first amplification fiber, wherein the unidirectional loop includes a second coupling device which is configured to couple pump light into the additional amplification medium.

The coupling device, whether it is the first coupling device or the second coupling device or a single coupling device, is preferably designed as a wavelength multiplex coupler (Wavelength Division Multiplexer - WDM).

According to one embodiment of the invention, it is provided that the unidirectional loop includes a reflecting arm, wherein a reflector element is arranged in the reflecting arm. According to one embodiment, additional optical functions can also be implemented via the reflector element, in particular the function of a bandwidth limiting element and/or a dispersion compensation element. The reflecting arm offers advantages in particular with regard to the arrangement and isolation on both sides of an additional amplification medium in the reflecting arm.

The reflecting arm preferably includes at least one fiber or preferably consists of at least one fiber.

The reflector element is preferably arranged at a reflection end of the reflecting arm. The reflecting arm is preferably designed as a linear branch of the unidirectional loop, which is connected in a light-conducting manner to a ring part of the unidirectional loop. The reflecting arm, in particular the linear branch, includes the reflector element at the reflection end and is connected in a light-conducting manner to the ring part at a connection end opposite to the reflection end. A light pulse passing through the unidirectional loop passes through the reflecting arm two times, once from the connection end to the reflection end and then back from the reflection end to the connection end.

The reflector element is preferably made partially transparent - or worded in reverse partially reflective - so that a predetermined proportion of light is decoupled from the fiber oscillator via the reflector element.

According to one embodiment of the invention, it is provided that the reflector element is designed as a wavelength fixing element, i.e., in particular as an element which is configured to define a central wavelength for the fiber oscillator. The reflector element therefore advantageously enables a unique fixing of the central wavelength at which the fiber oscillator is operated. This offers the great advantage of a high level of reproducibility with elevated variability at the same time, in order to obtain a desired wavelength as the central wavelength. This can be decisive in particular in following processes, the efficiency of which is dependent on the wavelength, for example in material processing processes, in an amplification chain, and/or in frequency conversion.

According to one embodiment of the invention, it is provided that the reflector element is designed as a fiber-Bragg grating. The fiber-Bragg grating can preferably function as a dispersion compensation element, as a wavelength fixing element, and/or as a bandwidth limiting element. To be able to function as a dispersion compensation element, the fiber-Bragg grating is preferably designed as a chirped fiber-Bragg grating. The fiber-Bragg grating can also act as a wavelength fixing element or as a bandwidth limiting element if it is designed as an unchirped fiber-Bragg grating.

According to one embodiment of the invention, it is provided that the reflecting arm is connected in a light-conducting manner via a circulator element to the ring part of the unidirectional loop. The circulator element is preferably used here at the same time as an isolator device of the unidirectional loop. The ring part includes a first ring branch, which is connected in a light-conducting manner at a first ring branch end to the 3×3 coupler - in particular to the third port - and at a second ring branch end to the reflecting arm. The ring part additionally includes a second ring branch, which is connected in a light-conducting manner at a first ring branch end to the reflecting arm and at a second ring branch end to the 3×3 coupler - in particular to the first port. A light pulse entering the first ring branch via the third port of the 3×3 coupler passes through it up to the circulator element, is coupled thereby into the connection end of the reflecting arm, passes through the reflecting arm up to the reflector element arranged at the reflection end, is at least partially reflected there, runs along the reflecting arm back to the connection end, is coupled there by the circulator element into the second ring branch, and passes through it up to the first port of the 3×3 coupler. The light pulse thus passes through the first ring branch and the second ring branch once in each case, while it passes through the reflecting arm twice – there and back.

According to one embodiment of the invention, it is provided that a second amplification fiber is arranged in the unidirectional loop, in particular as the above-mentioned additional amplification medium. The second amplification fiber is preferably arranged in the reflecting arm. This proves to be advantageous since in this way a light pulse propagating in the unidirectional loop passes through the second amplification fiber twice, so that the light pulse is double amplified. Furthermore, the second amplification fiber is advantageously separated by the circulator element - in particular in both directions - from the first amplification fiber, so that the two amplification fibers do not disadvantageously mutually influence one another.

The second amplification fiber is preferably doped using the same element as the first amplification fiber.

The fiber oscillator preferably includes, outside the unidirectional loop, in particular outside the loop arrangement - in the propagation direction of a light pulse decoupled by the reflector element - after the first reflector element a coupling device for coupling pump light into the fiber oscillator, in particular into the unidirectional loop. In this way, pump light can advantageously be coupled via the reflector element into the unidirectional loop. The coupling device can also be arranged within the unidirectional loop, in particular in the reflecting arm.

According to one embodiment of the invention, it is provided that the dispersion compensation element is formed by the reflector element, in that the reflector element is designed as a chirped fiber-Bragg grating.

Alternatively or additionally, the dispersion compensation element is preferably a dispersion-compensating fiber. The dispersion-compensating fiber is preferably arranged in the unidirectional loop.

Alternatively or additionally, the first amplification fiber is preferably made dispersion compensated.

According to one embodiment of the invention, it is provided that the fiber oscillator includes a bandwidth limiting element. Using the bandwidth limiting element, it is advantageously possible in particular to define a central wavelength for the fiber oscillator.

The bandwidth limiting element is preferably arranged in the unidirectional loop.

According to one preferred embodiment, the reflector element, in particular the fiber-Bragg grating, is designed as the bandwidth limiting element. In particular, the fiber-Bragg grating can also act as the bandwidth limiting element when it is designed as an unchirped grating.

Alternatively or additionally, the fiber oscillator includes a bandpass filter as the bandwidth limiting element.

According to one embodiment of the invention, it is preferably provided that the bandwidth limiting element, in particular the reflector element or bandpass filter, is designed to be adjustable with respect to its central wavelength. This enables a high level of flexibility in the selection of the central wavelength of the fiber oscillator. In one embodiment, the bandwidth limiting element is designed as a temperature-dependent grating, or as a grating which is sensitive with respect to its central wavelength in regard to elongation or compression.

According to one embodiment of the invention, it is provided that all optical components of the fiber oscillator are designed as polarization-maintaining. This proves to be a advantageous embodiment for the fiber oscillator.

According to one embodiment of the invention, it is provided that all optical components of the fiber oscillator are formed by fibers or consist of fibers, wherein they are in particular fiber-based components or fiber-coupled components. In particular, the fiber oscillator preferably does not include free-beam components. In this case, no adjustment effort results in conjunction with the fiber oscillator.

However, it is also possible according to another preferred embodiment that the fiber oscillator includes at least one optical component which is designed as a free-beam component.

The fiber oscillator preferably has a pulse repetition rate of 1 MHz to 150 MHz.

The object is also achieved in that a laser device is provided, which includes a pump light source and a fiber oscillator according to embodiments of the invention or a fiber oscillator according to one or more of the above-described exemplary embodiments. The pump light source and the fiber oscillator are connected to one another in a light-conducting manner, so that pump light of the pump light source can be coupled into the fiber oscillator. In particular the advantages which were already explained in conjunction with the fiber oscillator are implemented in conjunction with the laser device.

In particular, the pump light source is connected in a light-conducting manner to the first amplification fiber, so that pump light of the pump light source can be used to pump the first application fiber.

According to one embodiment of the invention, it is provided that the laser device includes a control device.

The control device is preferably operationally connected to a variably activatable asymmetry element of the bidirectional loop, in order to adjust the variable asymmetry element, in particular in order to adjust the nonlinear phase shift between the light pulses passing through the bidirectional loop in the reverse direction, in particular in such a way that the phase shift is at most 2π/3, preferably is 2π/3.

In particular, the control device is preferably operationally connected to a variably activatable amplification element in order to adjust the variably activatable amplification element with respect to its amplification.

In one embodiment, the control device is operationally connected to the pump light source and is configured to adjust a pulse duration of the fiber oscillator by selecting the pump power of the pump light source. The control device is preferably configured to select the pump power of the pump light source so that the nonlinear phase shift between the light pulses passing through the bidirectional loop in the reverse direction is at most 2π/3, preferably is 2π/3.

Alternatively or additionally, the control device is preferably operationally connected to a variably activatable attenuation element, in order to adjust the variably activatable attenuation element with respect to its attenuation, in particular in such a way that the nonlinear phase shift between the light pulses passing through the bidirectional loop in the reverse direction is at most 2π/3, preferably is 2π/3. In this way, a greater pulse duration range can preferably be covered than by selection of the pump power – possibly alone.

Alternatively or additionally, the control device is operationally connected to the bandwidth limiting element, which is adjustable with respect to its central wavelength, and is configured to adjust the central wavelength of the bandwidth limiting element. This advantageously enables a flexible selection and in particular also variation of the central wavelength of the fiber oscillator.

The fiber oscillator preferably also has a further filter element in addition to the adjustable bandwidth limiting element, wherein an overlap range between the bandwidth limiting element and the filter element can be adjusted by adjusting the bandwidth or central wavelength of the adjustable bandwidth limiting element. In this way, an effective bandwidth of the combination made up of the bandwidth limiting element and the filter element can be adjusted very efficiently and therefore the central wavelength can in turn be adjusted with high precision.

The bandwidth limiting element can in particular be thermally or mechanically adjustable, for example by heating or cooling, or by elongation or compression.

Adjustable bandwidth limiting can also be effectuated using a Fabry-Perot filter, in which a distance between two surfaces, which are responsible for the Fabry-Perot property, is changed.

The control device is preferably configured to generate a first, higher asymmetry in the bidirectional loop in a starting operating mode by activating the variably activatable asymmetry element, in order to promote rapid starting of the laser activity in the fiber oscillator, wherein the control device is configured to activate the variably activatable asymmetry element in order to generate a second, lower asymmetry in the bidirectional loop in a continuous operating mode, in order to ensure stable continuous operation of the fiber oscillator. In particular, the control device is configured to activate a variably activatable attenuation element accordingly, in particular to set a first, higher attenuation in the starting operating mode and to set a second, lower attenuation in the continuous operating mode.

Embodiments of the present invention also provide a method for operating a fiber oscillator according to one or more of the above-described embodiments, wherein – in particular by activating a variably activatable asymmetry element – a first, higher asymmetry is generated in the bidirectional loop in a starting operating mode, and wherein a second, lower asymmetry is generated in the bidirectional loop in a continuous operating mode. In particular in the context of the method, with a variably activatable attenuation element, a first, higher attenuation is preferably set in the starting operating mode, wherein a second, lower attenuation is set in the continuous operating mode.

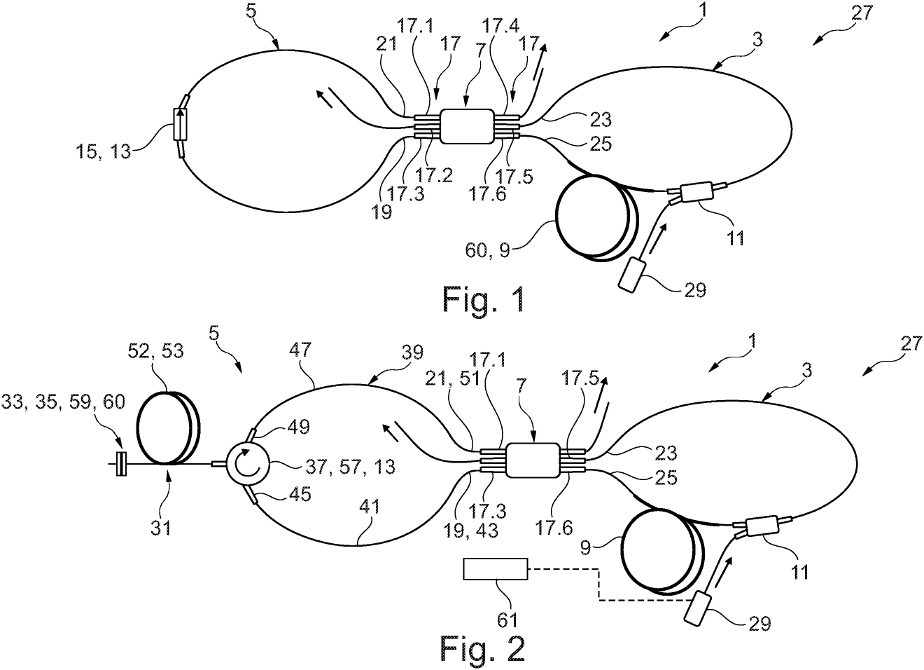

FIG. 1 shows a schematic illustration of a first exemplary embodiment of a passive mode-coupled fiber oscillator 1. The fiber oscillator 1 includes a bidirectional loop 3 and a unidirectional loop 5, wherein the bidirectional loop 3 and the unidirectional loop 5 are coupled to one another by a 3×3 coupler 7, in particular connected in a light-conducting manner. A first amplification fiber 9 is arranged in the bidirectional loop 3, which is doped using at least one element selected from a group consisting of: ytterbium, neodymium, erbium, thulium, and holmium. The first amplification fiber 9 can also be doped using a combination of at least two of the mentioned elements, in particular using a combination of precisely two of these elements. The fiber oscillator 1 includes a dispersion compensation element 60 and overall has an anomalous dispersion. In particular, it is possible that the first amplification fiber 9 is itself designed or acts as a dispersion compensation element 60. The bidirectional loop 3 can advantageously assume the function of a saturable absorber here, so that the fiber oscillator 1 can in particular dispense with a SESAM. The problem of degradation and misalignment in conjunction with a SESAM is therefore also completely avoided. In particular, no problems with degradation and/or misalignment occur in conjunction with the bidirectional loop 3. By suitable selection of the first amplification fiber 9, in particular an element using which the first amplification fiber 9 is doped, suitable wavelengths can be provided for the fiber oscillator 1, in particular in the range of approximately 900 to 1100 nm (ytterbium or neodymium) via 1500 nm (erbium) to approximately 1900 to 2100 nm (thulium or holmium). Well-defined dispersion properties are advantageously provided by tuning of the overall dispersion of the fiber oscillator 1 in the anomalous range.

The bidirectional loop 3 preferably has an asymmetry for two light pulses, which pass through the bidirectional loop 3 in opposite directions. This asymmetry can in particular be effectuated by asymmetrical amplification and/or asymmetrical attenuation in the bidirectional loop 3. In the exemplary embodiment shown here, the first amplification fiber 9 is arranged asymmetrically in the bidirectional loop 3. In particular, the bidirectional loop 3 is designed as a nonlinear amplifying loop mirror (NALM).

A coupling device 11 for coupling in pump light is preferably arranged in the bidirectional loop 3. The coupling device 11 is preferably designed as a wavelength division multiplexer (WDM).

An isolator device 13, in particular an isolator 15, is preferably arranged in the unidirectional loop 5.

The 3×3 coupler 7 is preferably configured to convey a phase shift of 2π/3 to light pulses which cross talk between various direct connections of a plurality of ports 17 of the 3×3 coupler 7. A corresponding phase shift is then conveyed in particular to opposing light pulses in the NALM.

An embodiment of the 3×3 coupler 7 is described hereinafter on the basis of FIG. 1 in consideration of a possible arrangement and linking of the ports 17 of the 3×3 coupler 7. Numerous other embodiments are possible which are equivalent, nearly equivalent, or at least functionally equal to the described arrangement, but in any case fulfill the same purpose.

According to the exemplary embodiment illustrated here, the 3×3 coupler 7 includes in particular a first port 17.1, a second port 17.2, a third port 17.3, a fourth port 17.4, a fifth port 17.5, and a sixth port 17.6. A first end 19 of the unidirectional loop 5 is connected in a light-conducting manner to the third port 17.3. A second end 21 of the unidirectional loop 5 is connected in a light-conducting manner to the first port 17.1. Light pulses can propagate along the unidirectional loop 5 only from the third port 17.3 to the first port 17.1 due to the design and arrangement of the isolator device 13. A first end 23 of the bidirectional loop 3 is connected in a light-conducting manner to the fifth port 17.5. A second end 25 of the bidirectional loop 3 is connected in a light-conducting manner to the sixth port 17.6. The second port 17.2 and the fourth port 17.4 are preferably used to decouple light pulses from the fiber oscillator 1, whether as useful light or for monitoring.

A light pulse entering from the unidirectional loop 5 via the first port 17.1 into the 3×3 coupler 7 is allocated by the 3×3 coupler 7 in three light pulses having equal pulse energy on the fourth port 17.4, the fifth port 17.5, and the sixth port 17.6. The light pulses at the fifth port 17.5 and at the sixth port 17.6 each experience a phase shift of 2π/3 in relation to the light pulse entering at the first port 17.1. The light pulse at the fifth port 17.5 is designated hereinafter as the first light pulse, the light pulse at the sixth port 17.6 as the second light pulse. The first light pulse now passes through the bidirectional loop 3 starting from its first end 23 toward its second end 25, wherein the second light pulse passes through the bidirectional loop 3 in the reverse direction.

Due to the first amplification fiber 9 arranged asymmetrically in the bidirectional loop 3, the first light pulse and the second light pulse experience different phase shifts or B integrals during their propagation along the bidirectional loop 3. The difference in the B integrals or the phase shift between the first light pulse and the second light pulse is dependent in particular on the original intensity of the light pulses – before passing through the bidirectional loop 3 – and the amplification in the first amplification fiber 9, thus in particular on a pump level of the first amplification fiber 9.

Arriving at the fifth port 17.5, the second light pulse now partially cross talks via a direct optical connection between the sixth port 17.6 and the third port 17.3 and again experiences a phase shift of 2π/3.The first light pulse arriving at the sixth port 17.6 is passed on directly to the third port 17.3 without experiencing a phase shift. An output pulse at the third port 17.3 resulting by superposition of the first light pulse and the second light pulse is therefore in particular dependent on the B integrals, which the light pulses experience during their propagation along the bidirectional loop 3.

Light components which arrive back in the first port 17.1 are eliminated by the isolator device 13. Only light pulses are let through which enter the unidirectional loop 5 via the third port 17.3. The bidirectional loop 3 functions as a saturable absorber.

In the first exemplary embodiment of the fiber oscillator 1, the unidirectional loop 5 does not include an amplification medium. In particular, the first amplification fiber 9 is the only amplification medium here, in particular the only amplification fiber of the fiber oscillator 1.

FIG. 1 also shows an exemplary embodiment of a laser device 27, which includes a pump light source 29 and the fiber oscillator 1, wherein the pump light source 29 is connected in a light-conducting manner to the fiber oscillator 1, in particular to the coupling device 11, so that pump light of the pump light source 29 can be coupled into the fiber oscillator 1.

FIG. 2 shows a schematic illustration of a second exemplary embodiment of the fiber oscillator 1.

Identical and functionally identical elements are provided with identical reference signs in all figures, so that reference is insofar made in each case to the preceding description.

In this exemplary embodiment, the unidirectional loop 5 includes a reflecting arm 31, in which, in the second exemplary embodiment shown here, a reflector element 35 designed as a fiber-Bragg grating 33 is arranged. The reflecting arm 31 is connected via a circulator element 37 in a light-conducting manner to a ring part 39 of the unidirectional loop 5. In particular, the ring part 39 includes a first ring branch 41, which is connected at a first ring branch end 43 to the third port 17.3 of the 3×3 coupler 7, wherein it is connected at a second ring branch end 45 to the circulator element 37. The ring part 39 additionally includes a second ring branch 47, which is connected at a first ring branch end 49 to the circulator element 37 and at a second ring branch end 51 to the first port 17.1 of the 3×3 coupler 7. The circulator element 37 acts here as the isolator device 13. A light pulse passing through the unidirectional loop 5 starting from the third port 17.3 to the first port 17.1 passes through the ring branches 41, 47 once in each case, but the reflecting arm 31 twice, namely once toward the reflector element 35 and once back from the reflector element 35.

A second amplification fiber 53 is arranged in the reflecting arm 31 as an amplification medium 52, which is preferably doped using the same element using which the first amplification fiber 9 is also doped. The amplification medium 52, in particular the second amplification fiber 53, can also be arranged at another point in the fiber oscillator 1.

The reflector element 35 is preferably designed as partially transmitting or partially reflecting, wherein, on the one hand, a predetermined proportion of light is decoupled via the reflector element 35 from the fiber oscillator 1, wherein, on the other hand, pump light for the second amplification fiber 53 is preferably coupled via the reflector element 35 into the unidirectional loop 5.

The circulator element 37 acts in particular as an isolator element 57 in the unidirectional loop 5.

The reflector element 35 is preferably designed as a bandwidth limiting element 59; in particular, the fiber-Bragg grating 33 - unchirped according to one embodiment - is preferably designed as a bandwidth limiting element 59. The bandwidth limiting element 59 is preferably used to define a central wavelength for the fiber oscillator 1. According to one preferred embodiment, it is possible that the bandwidth limiting element 59 is adjustable with respect to its central wavelength.

In particular if the fiber-Bragg grating 33 is designed as a chirped fiber-Bragg grating 33, it can alternatively or additionally function as a dispersion compensation element 60.

FIG. 2 additionally shows a second exemplary embodiment of the laser device 27, which includes a control device 61 in one preferred embodiment, wherein the control device 61 is operationally connected to the pump light source 29 and is configured to set a pulse duration of the fiber oscillator 1 by selecting the pump power of the pump light source 29.

In one preferred embodiment, the control device 61 can be operationally connected to the bandwidth limiting element 59 to adjust its central wavelength.

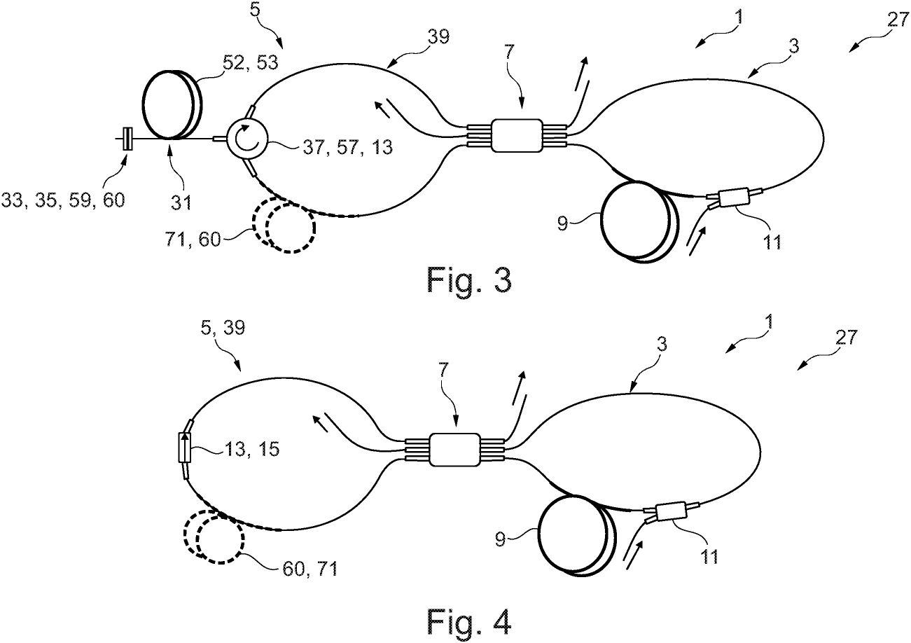

FIG. 3 shows a schematic illustration of a third exemplary embodiment of the fiber oscillator 1. In this third exemplary embodiment, a dispersion-compensating fiber 71 is arranged as a dispersion compensation element 60 in the unidirectional loop 5.

In particular with the aid of the dispersion compensation element 60, independently of its design - in particular according to FIG. 2, FIG. 3, or FIG. 4 below - it is possible to reduce the absolute value of the overall dispersion of the fiber oscillator 1, in particular to bring it closer to the normal dispersion range, so that pulses which are spectrally broader and therefore shorter with respect to time are obtained.

FIG. 4 shows a schematic illustration of a fourth exemplary embodiment of the fiber oscillator 1.

In this fourth exemplary embodiment, the unidirectional loop 5 consists of the ring part 39 - accordingly it does not have a reflecting arm 31 - and includes the dispersion-compensating fiber 71 as the dispersion compensation element 60 in the ring part 39.

Independently of the design of the fiber oscillator 1 - in particular according to one of the above-described exemplary embodiments - preferably all optical components of the fiber oscillator 1 are designed as polarization-maintaining.

Preferably, all optical components of the fiber oscillator 1 are fiber components or fiber-based components or fiber-coupled components. In particular, the fiber oscillator 1 preferably does not include any free-beam components.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C

1. A passive mode-coupled fiber oscillator, comprising:
a bidirectional loop,
a unidirectional loop, and
a 3×3 coupler, wherein the bidirectional loop and the unidirectional loop are coupled to one another via the 3×3 coupler,
wherein the bidirectional loop includes a first amplification fiber that is doped using at least one element selected from the group consisting of ytterbium, neodymium, erbium, thulium, and holmium,
the fiber oscillator further comprising a dispersion compensation element, and wherein
the fiber oscillator has an anomalous dispersion overall.

2. The fiber oscillator as claimed in claim 1, wherein the 3×3 coupler is configured to convey a phase shift of 2π/3 to light pulses that cross talk between various direct connections of ports of the 3×3 coupler.

3. The fiber oscillator as claimed in claim 1, wherein
the unidirectional loop does not include an amplification medium.

4. The fiber oscillator as claimed in claim 1, wherein
the unidirectional loop includes an amplification medium and an isolator element arranged between the amplification medium and the first amplification fiber.

5. The fiber oscillator as claimed in claim 1, wherein the unidirectional loop includes a reflecting arm and a reflector element arranged in the reflecting arm.

6. The fiber oscillator as claimed in claim 5, wherein the reflector element is configured as a wavelength fixing element.

7. The fiber oscillator as claimed in claim 5, wherein the reflector element is configured as a fiber-Bragg grating.

8. The fiber oscillator as claimed in claim 5, wherein the unidirectional loop further includes a circulator element, the reflecting arm is connected in a light-conducting manner via the circulator element to a ring part of the unidirectional loop.

9. The fiber oscillator as claimed in claim 5, wherein the unidirectional loop further includes a second amplification fiber that is doped using a same element as the first amplification fiber, the second amplification fiber is arranged in the reflecting arm.

10. The fiber oscillator as claimed in claim 1, wherein
the unidirectional loop includes a reflecting arm, the dispersion compensation element is formed as a reflector element arranged in the reflecting arm, and the reflector element is configured as a chirped fiber-Bragg grating.

11. The fiber oscillator as claimed in claim 1, wherein
the dispersion compensation element comprises a dispersion-compensating fiber arranged in the unidirectional loop.

12. The fiber oscillator as claimed in claim 1, further comprising a bandwidth limiting element arranged in the unidirectional loop.

13. The fiber oscillator as claimed in claim 12, wherein the bandwidth limiting element is configured to be adjustable with respect to a central wavelength.

14. The fiber oscillator as claimed in claim 1, wherein all optical components of the fiber oscillator are configured to be polarization-maintaining.

15. A laser device, comprising a pump light source and a fiber oscillator as claimed in claim 1, wherein the pump light source and the fiber oscillator are connected to one another in a light-conducting manner, so that pump light emitted by the pump light source is capable of being coupled into the fiber oscillator.

16. The laser device as claimed in claim 15, further comprising a control device, wherein
the control device is operationally connected to the pump light source and is configured to adjust a pulse duration of the fiber oscillator by selecting a pump power of the pump light source.

17. The laser device as claimed in claim 15, further comprising a control device operationally connected to a bandwidth limiting element of the fiber oscillator, the bandwidth limiting element configured to be adjustable with respect to a central wavelength, and the control device is configured to set the central wavelength of the bandwidth limiting element.
